(19) United States
(12) Patent Application Publication
(10) Pub. No.: US 2014/0216223 A1
(43) Pub. Date: Aug. 7, 2014

(54) Methods for Producing Workpieces from a Plate-Shaped Material

(71) Applicant: TRUMPF Werkzeugmaschinen GmbH + Co. KG, Ditzingen (DE)

(72) Inventor: Peter Epperlein, Ditzingen (DE)

(73) Assignee: TRUMPF Werkzeugmaschinen GmbH + Co. KG, Ditzingen (DE)

(21) Appl. No.: 14/350,586

(22) PCT Filed: Sep. 18, 2012
(86) PCT No.: PCT/EP2012/068283

§ 371 Date: Apr. 9, 2014

(30) Foreign Application Priority Data
Oct. 10, 2011 (DE) 10 2011 054 361.9

(51) Int. Cl. B26D 3/00

(52) U.S. Cl. CPC B26D 3/00
USPC 83/23

(57) ABSTRACT

Methods for producing workpieces from a plate-shaped material by a severing process on a machine tool having a workpiece support comprising first and second support surfaces that can be arranged relative to each other to define a cutting gap positioned below a processing area of the machine. Cuts for waste parts and/or parts of a skeleton are made in the plate-shaped material in order to produce the at least one workpiece, such that at least one last severing cut for the one or more workpieces for completely separating the one or more workpieces from the plate-shaped material remains. The waste parts and/or parts of a skeleton are removed through the cutting gap, and then the one or more workpieces are cut free from the plate-shaped material as a last severing cut in such a way that a movement of a cut workpiece over the cutting gap again is omitted.

### TECHNICAL FIELD

This invention relates to a method for producing workpieces from a plate-shaped material using a separation procedure in a machine tool.

### BACKGROUND

A 2D laser processing machine is known from WO 2007/137613 A1 which has a workpiece support which comprises several supporting elements that are arranged parallel to one another. Each of these supporting elements comprises bearing point tips arranged at intervals to one another, on which the plate-shaped material is supported. Such contact points between the bearing point tips and the plate-shaped material can negatively affect the workpiece quality during the cutting process, as it can lead to scratching of the supporting side of the plate-shaped material as well as cementing with bearing point tips.

Alternatively to such laser processing machines, so-called sheet mover hybrid systems are already known, in which the plate-shaped material is supported by roller or brush tables, which form a workpiece support. The plate-shaped material is clamped by a gripper unit and is moved relatively to the processing region of the workpiece support with this gripper unit. Such alternative laser processing machines prevent a scratching and, if necessary, cementing of the underside of the plate-shaped material.

Furthermore, a laser processing machine is known from JP 2003290968, in which the plate-shaped material is likewise clamped by a clamp device. The plate-shaped material is supported on a work piece support, which is formed by two workpiece supporting tables, which have deflection rollers pointing towards the cutting gap, which are able to move in and against the X-direction. In this way, the processing region within the laser processing machine does not need to be enlarged due to a movement of the cutting gap, but comprises a constant construction size. The plate-shaped material having the cut workpieces is transferred outwards via an outward transfer belt, which is aligned with the plane of the supporting table.

A further laser processing machine is known from JP 2008200701 A, which has a workpiece supporting surface made from two supporting tables. One of the two supporting tables is arranged in a fixed manner on the base body. The second supporting table, which is adjacent to the cutting gap, can be retracted from the processing region completely into a loading zone. A further supporting table is inserted into the processing region of the laser cutting machine during this, in order to carry out a subsequent processing of the plate-shaped material. A removal of the processed plate-shaped material occurs via the previously retracted supporting table.

WO 2007/003299 A1 describes a machine tool having a workpiece support to support plate-shaped materials for processing with a separating device. This has a processing head which is able to move in at least the Y direction during a separation procedure in the plate-shaped material. The workpiece support comprises a first supporting table having a first supporting surface and a second supporting table having a second supporting surface, whereby the supporting surfaces are at a distance to each other to form a gap underneath the processing head. The position and width of the gap can also be adapted in the processing region of the separating device during the separation procedure.

Furthermore, a machine tool is known from JP 2006192465 A, in which the plate-shaped material is held in a fixed manner by a clamp device and is supplied to a processing head. To produce workpieces, a separating cut is first introduced into the plate-shaped material in a peripheral region pointing towards the processing head, in order to separate the workpiece completely from the plate-shaped material. Subsequently, the supporting surface of the plate-shaped material is lowered, and the plate-shaped material is held in a raised position by the clamp device, such that the workpiece can fall downward. This workpiece is then transported away.

### SUMMARY

A method is desired for producing workpieces by means of a separation procedure using a separating device in a machine tool, in which the work piece is cut free in a reliable process and an increased productivity is provided.

In one aspect of the invention, a plate-shaped material is supported on supporting surfaces of two supporting tables configured to be arranged with respect to each other to form a cutting gap positioned under the processing head during processing. Separating cuts for waste parts and/or parts of the skeleton are introduced into the plate-shaped material to produce at least one workpiece, such that at least one last separating cut remains for the complete separation of the workpiece(s) from the plate-shaped material, with the waste parts and/or parts of the skeleton being removed through the cutting gap. Subsequently, the workpiece(s) are cut free from the plate-shaped material in such a way that does not involve again moving a cut workpiece over the cutting gap.

In some embodiments the workpiece, which is connected to the plate-shaped material, is supported as far as possible on the second supporting table, if the last separating cut is introduced, such that the workpiece is no longer moved over the gap after it is cut free, but is removed from the gap by the second supporting table and transported away. Thus the catching and tipping of the workpiece can be prevented and a continuous processing of the plate-shaped material is enabled in the X direction.

The method can also provide a reactionless separation and cutting free of work pieces, as well as a separate removal of waste and skeleton parts on the one hand, and work pieces on the other. Thus a high quality of workpieces and a reduction of the work cycles to produce the workpieces are enabled.

In a preferred embodiment of the method, the plate-shaped material is supported on the first supporting table and is positioned with a front-side peripheral region towards the cutting gap, such that, subsequently, separating cuts for waste parts and/or parts of the skeleton are introduced into the front-side peripheral region of the plate-shaped material to produce the at least one workpiece, with at least one last separating cut remaining for the complete separation of the workpiece(s) from the plate-shaped material. Waste parts and/or parts of the skeleton are removed through the cutting gap. The workpiece(s) are cut free and are transported away by the second supporting table. Thus, the plate-shaped material can be continuously processed from one side outwards. Additionally, waste parts and/or parts of the skeleton on the one hand, and the workpieces on the other hand, can be separately removed from the processing region. Thus the danger of them catching on one another is prevented. Additionally, a sorting between waste parts and workpieces can already occur. This method enables the workpieces to be transported away during primary processing time via one of the two supporting tables. After the workpiece(s) are cut free, they are preferably transported away by the second supporting table before the plate-shaped material is processed further. Thus the process reliability is further increased.

Furthermore, the waste parts and/or parts of the skeleton can also be transferred into the unloading zone via the second work table separate from the workpieces. For this purpose, a supporting element of the second work table is preferably powered in order to transfer the individual parts of the skeleton and/or the waste parts from the processing region into an unloading zone, with the workpiece remaining connected to the plate-shaped material via the connecting section for the last separating cut to be introduced. Thus, a separate retraction of the waste parts and/or parts of the skeleton occurs, and this only applies for such parts which are formed without undercuts to the workpiece in the X direction and can be transported away. The plate-shaped material lies stationary on the first supporting table and is preferably held by a clamping device fixed to the processing region.

If the waste parts and/or the parts of the skeleton are exclusively transferred downwards through the cutting gap between the two supporting tables, then this has the advantage that the waste parts and/or the parts of the skeleton, which have an undercut with regard to the direction of transport (in the X direction relative to the workpiece) are transferred downward in a simple way. Subsequently, there is no distinction between waste parts or parts of the skeleton that are free of undercuts or that have an undercut, if all of these parts are transferred downward. Additionally, a continuous production of the workpieces can be enabled. Alternatively, small waste parts can be transferred downward and large parts can be transported away via the further second supporting table as well as, afterward, the workpieces via the second supporting table.

A further preferred embodiment of the invention provides that the workpieces are nested inside strip-shaped sections on the front-side peripheral region pointing towards the cutting gap, and the plate-shaped material is processed to be strip-shaped. This positioning for the nesting of the workpieces enables a movement of the supporting table or the cutting gap towards the processing head to be considerably minimized. Thus the process times can be shortened.

Preferably the nesting of the workpieces is determined such that a mutual last separating cut is introduced into several work pieces within a set width of the cutting gap. Thus, a further optimization can be achieved in the case of the strip-shaped sections, whereby, in particular, the processing head carries out a movement in the Y direction and can separate several workpieces from the plate-shaped material one after the other, which are transported away sequentially. Additionally, a control of the supporting table can be reduced in that preferably a pre-set size of the gap width is fulfilled in order to carry out a mutual separating cut for several workpieces.

Furthermore, preferably in the case of a stationary plate-shaped material arranged in the processing space, the second supporting table moves in the X direction or a supporting element of the second supporting table is powered such that a movement of supporting workpieces occurs in the X direction. Thus a conveyance, in particular a staggered conveyance, of the workpieces from the processing region into an unloading zone can occur after the workpieces are cut free from the plate-shaped material. The individual workpieces that have been cut free can be extracted little by little, preferably by a handling device, in a controlled manner by the supporting table.

In an unloading zone, which, in particular, is adjacent to the second supporting table, a handling device, a storage container or batch container can be positioned. Depending on the further handling steps or integration into an automated assembly line, the workpieces can be handled accordingly. The handling device can remove the workpieces individually from the second supporting table and, for example, position them in an aligned manner in the storage container or transfer them onto a further transport belt, such that a subsequent further processing occurs. Alternatively, the workpieces can also be removed by a universal surface gripper or be deposited into a batch container or storage container directly, originating from the supporting table.

Another aspect of the invention features a method in which separating cuts are first introduced into waste parts that lie within the workpiece or bordering the workpiece. These waste pasts are subsequently transferred downward through the cutting gap between the two supporting tables. The gap between the supporting tables is subsequently set to a gap width smaller than the smallest part size of the workpiece, and then the outer contour of the workpieces is cut at least partially or completely, with the workpieces remaining in the skeleton and being removed from the processing region together with the skeleton. This alternative aspect of the method likewise has the advantage with regard to the production of the workpieces in the throughput time of the plate-shaped material, as a cutting up of the skeleton or the production of the parts of the skeleton for the downward transfer through the cutting gap or a separate transporting away is not necessary.

A preferred embodiment of the method provides that the workpieces, which fall below a critical parts size, are separated from the plate-shaped material by a separating cut to produce the outer contour of the workpieces such that at least one micro joint remains. Thus the workpieces which fall below a critical size, in particular those which have a longitudinal extension smaller than 100 mm, are held in the skeleton by such micro joints and are conveyed out of the processing space together with the skeleton.

Preferably the micro joints are positioned between the workpiece and the skeleton such that these are arranged on the side of the workpiece facing away from the transfer direction. Thus the workpiece must no longer be conveyed over the cutting gap after the micro joint is cut free. After the workpiece has been conveyed substantially over the cutting gap in the direction of the unloading zone, the micro joint is separated during the transfer procedure. Thus the workpiece remains loosely in the skeleton and can be brought into an unloading zone together with the skeleton without again moving over the gap.

A preferred embodiment of the method provides that the plate-shaped material is held in a fixed manner with a clamp in the processing space. Thus, the precise processing of the workpiece is increased, in particular if several separating cuts are required to produce a workpiece.

The invention as well as further advantageous embodiments and developments of the same are described and explained in more detail below by means of the examples depicted in the drawings. The features to take from the description and the drawings can be applied individually or several together in any combination according to the invention.

### DESCRIPTION OF DRAWINGS

FIG. 1 is a schematic side view of a machine tool.

FIG. 2 a perspective view of the machine tool of FIG. 1, sectioned along the X direction.

FIG. 3 is a schematic side view of the machine tool of FIG. 1, showing the workpiece support.

FIG. 4 is a schematic side view of an alternative embodiment of the workpiece support to that of FIG. 3.

FIG. 5 is a view from above of the processing of the plate-shaped material according to a first embodiment of the method.

FIG. 6 is a perspective view of a further machine tool to carry out the method of FIG. 5.

FIGS. 7a to 7f sequentially illustrate individual process steps to carry out the method of FIG. 5 for producing a given workpiece,

FIG. 8 is a perspective view of the machine tool of FIG. 1 having a partially processed plate-shaped material according to a further alternative embodiment of the method.

FIGS. 9a to 9d sequentially illustrate individual process steps to carry out an alternative method to that in FIGS. 7a to 7f.

### DETAILED DESCRIPTION

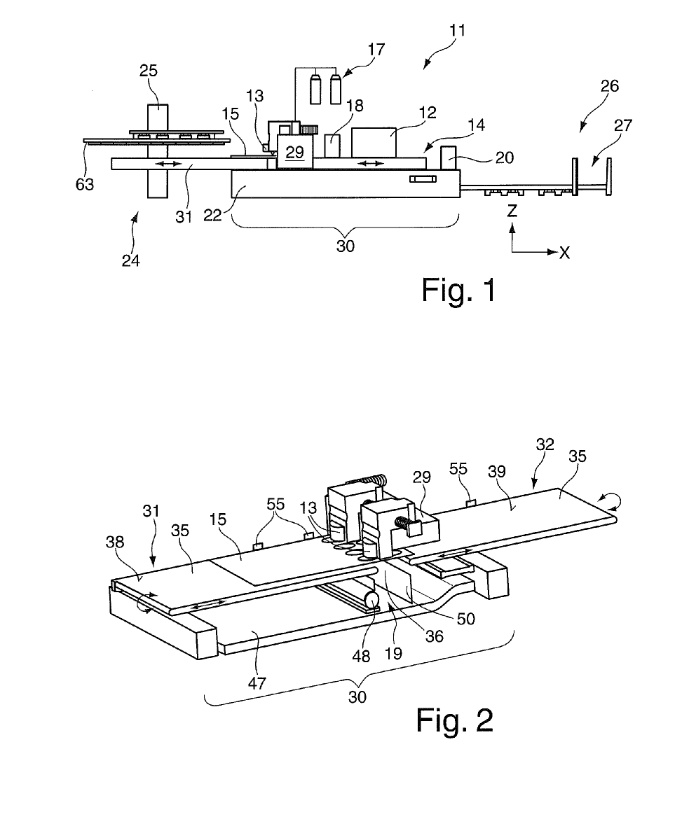

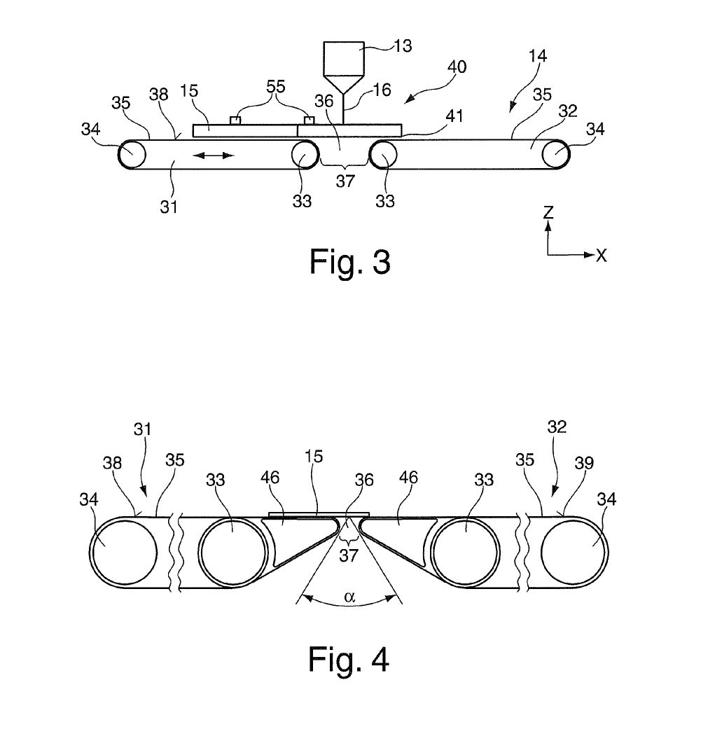

In FIG. 1, a principal structure of a machine tool 11 formed as a laser cutting machine is depicted. Further exemplary embodiments are, for example, a laser welding machine or a combined punching/laser cutting machine. The laser cutting machine has a CO₂ laser or a solid state laser as a laser beam generator 12, which directs a laser beam on to a workpiece support 14 via a processing head 13. A plate-shaped material 15 is arranged on this workpiece support 14. A laser beam 16 (FIG. 3) is generated by the laser beam generator 12. This laser beam 16 is directed from the CO₂ laser with the help of deflection mirrors that are not depicted, or from a solid state laser with the help of a light conducting cable that is not depicted, to the processing head 13. The laser beam 16 is directed onto the plate-shaped material 15 by means of a focusing device arranged in the processing head 13. The laser processing machine 11 is additionally provided with cutting gases 17, for example with oxygen or nitrogen. Alternatively or additionally, pressurized air or application-specific gases can be provided. The use of the individual gases is dependent on the workpiece of the plate-shaped material 15 to be processed and on quality requirements at the cutting edges. Furthermore, a suction device 18 is provided which is connected to a suction chamber 19 which is situated under the workpiece support 14 (FIG. 2).

During the cutting of a workpiece 21 from the plate-shaped material 15 using oxygen as a cutting gas, the material of the plate-shaped material 15 is melted and largely oxidized. In the case of the use of inert gases, such as, for example, nitrogen or argon, the material is only melted. The resulting molten particles are then, if necessary, exhausted together with the iron oxides and are sucked up together with the cutting gas via the suction chamber 19 via the suction device 18.

This laser processing machine 11 is controlled via a control 20. A loading zone 24 having a loading device 25 as well as an unloading zone 26 having an unloading device 27 can be provided adjacent to a base body 22 of the laser cutting machine 11.

In FIG. 2, a perspective view of the laser cutting machine 11 is depicted in a sectional cut in an enlarged manner without loading and unloading zones 24, 26, such that the components arranged in the base body 22 are visible in more detail.

In the case of this embodiment, for example two processing heads 13 are provided instead of only one, which are able to move in the X direction along a processing region 30 via a mutual linear device 29. The processing region 30 is formed over the size of the frame of the base body 22 or is determined by the size of the movement range of the linear unit 29. The linear device 29 has a linear axis in order to move the two processing heads 13 independently in and against the Y direction.

The workpiece support 14 comprises a first and second supporting table 31, 32, which are able to move independently of each other in and against the X direction in the base body 22, and are also able to be positioned outside of the base body 22. According to a first embodiment, it is provided, as is depicted in FIG. 3, that the supporting tables 31, 32 have deflection rollers 33, 34 each arranged in a fixed manner with respect to each other, which receive an endless belt as a supporting element 35. A first supporting surface 38 for the first supporting table 31 and a second supporting surface 39 for the second supporting table 32 are formed between the deflection rollers 33, 34 by the supporting element 35. The respective rollers 33 of the supporting table 31, 32 are allocated to each other and form a gap 36, the gap width 37 of which is able to be set in width and also in the position within the processing region 30 of the base body 22 due to the independently movable supporting tables 31, 32. One or both deflection rollers 33, 34 are powered such that the supporting element 35 can optionally be powered in or against the X direction.

The supporting tables 31, 32 can alternatively have rollers or brushes as supporting elements 35 which are likewise powered.

Additionally, an outward transfer element that is not depicted in more detail can be provided, which preferably extends over the width of the processing region 30 or into the width of the supporting tables 31, 32. If necessary, a narrow width is provided in order to receive the outward transfer element within a moveable frame of the supporting tables 31, 32, such that the outward transfer element is able to be arranged as an extract for the extension of the supporting surfaces 38,39 of the supporting tables 31, 32, for example, in order to be moveable, on the one hand completely under the gap 36 and on the other hand in the direction of the loading and/or unloading zone 24, 26, and to form an extension. The outward transfer element can be formed analogically to the supporting table 31, 32.

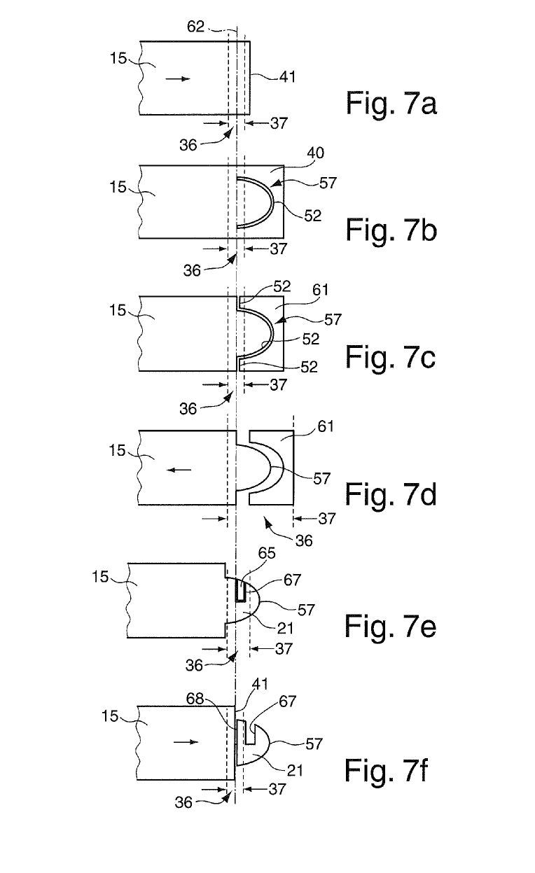

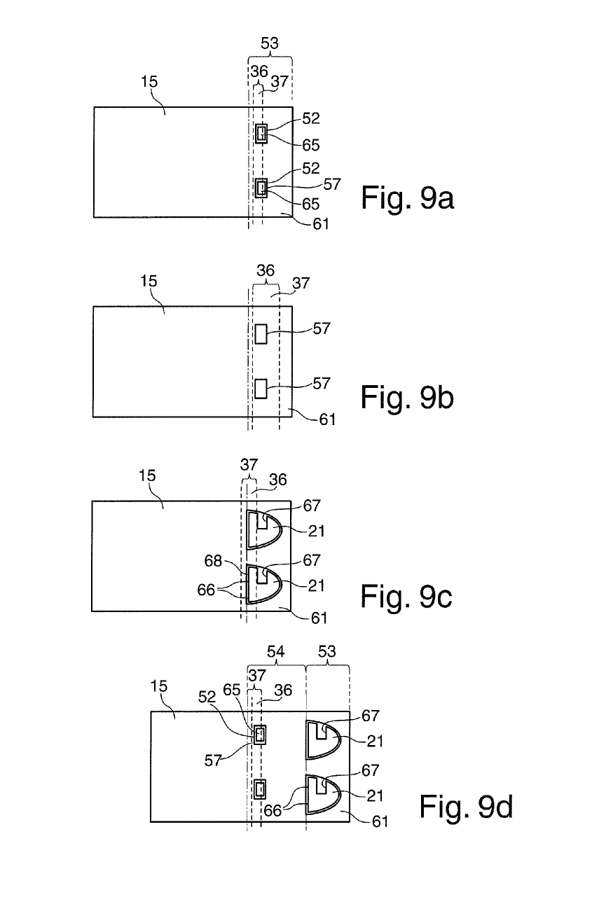

A transport device 47 is provided underneath the workpiece support 14, for example on the base of the base body 22, in particular as a longitudinal conveyor belt, which extends along the processing region 30. This longitudinal conveyor belt serves to receive waste parts 65 falling through the cutting gap 36 (FIGS. 7 and 9), such as, for example, slugs, inner contours or other cuttings. In this case a closed beam safety catch, carried underneath the cutting gap 36 is not provided.

Furthermore, a movement unit coupled to the linear device 29 is preferably provided underneath the cutting gap 36, said movement unit carrying a suction hood 48. This suction hood 48, which is part of the suction chamber 19 or forms the suction chamber 19, is connected to the suction device 18. Furthermore, at least one bulk head plate 50 is provided adjacent the gap 36 and, in particular, is able to be set to the position and/or width of the gap 36 to form a shielding of the space extending downward in the base body 22 at the gap 36, into which space the cutting beam 16 enters. Thus, a targeted suction of cutting gas, melting loss, etc., is enabled.

In FIG. 3, a schematic side view of the workpiece support 14 of the machine tool 11 is principally depicted. Using a movement of the supporting table 31, 32 in and against the X direction, a gap width 37 can be set in order to transfer waste parts 65 and/or parts of the skeleton 61 downwards through the gap 36. In a first process step, the gap width 37 of the cutting gap 36 is set such that this position and size of the gap 36 is adjusted to the cutting beam 16 for the first separating cut(s). Subsequently, a changed width can be set in order to transfer the waste parts 65 and/or the parts of the skeleton 61 downward.

A plate-shaped material is introduced into the processing space 30 via the first supporting table 31. For this purpose, the supporting table 31 can be moved into the loading zone 24, so that the loading device 25 deposits a plate-shaped material onto the supporting surface 38 of the supporting table 31. Subsequently, the supporting table 31 is moved again into the processing space. Therein, a movement of the supporting table 31 in the X direction and additionally a drive movement of the supporting element 35 can be provided. The plate-shaped material 15 is gripped and fixed by the clamp device 55 in the processing region 30. At the beginning of a first work step for the method described below, a front-side peripheral region 40 of the plate-shaped material 15 is positioned towards the cutting gap 36 such that the front-side peripheral region 40 lies over the cutting gap 36. There, a front edge 41 of the front-side peripheral region 40 can be supported on the opposite supporting table 32 or can be adjacent a gap-side periphery of the supporting table 32, which is formed by the deflection roller 33 of the second supporting table 32, or can lie partially inside the cutting gap 36. From this starting position, the embodiment variants of the method to produce workpieces described below are described in more detail. Substantially, it is provided that using a continuous supply movement of the plate-shaped material 15 in the X direction, a processing of this plate-shaped material 15 occurs such that there is no repeated moving of the cut workpieces 11 over the cutting gap 36, in order to increase the process reliability in that catching and tipping of the workpieces 21 is prevented. The continuous supply movement of the plate-shaped material 15 can occur using the clamping device 55. Likewise the clamp device 55 can be arranged to be fixed in place in the processing region 30 and the supporting tables shift underneath the plate-shaped material 15 together with the processing head 13, such that cutting gap 36 is carried underneath. Additionally, a combination of the two aforementioned alternatives can also occur in that the clamp device 55 is moved little by little in the X direction and the supporting tables 31, 32 are moved opposed to this accordingly, wherein preferably the supporting elements 35 are powered in order to prevent a relative movement between the supporting element 35, in particular the first supporting table 31, and the plate-shaped material 15.

In FIG. 4, an alternative embodiment of the supporting tables 31, 32 to the embodiment in FIG. 3 is depicted. In the case of this embodiment, belt directing elements 46 pointing towards the cutting gap 36 are provided which enable a constriction of the cutting gap 36 on the one hand, however reduce the depth of the cutting gap 36 relative to the deflection rollers 33, such that an enlarged opening angle α results and the cutting beam 16 can extend downwards without damage to the supporting elements 35 of the supporting table 31, 32. These belt guiding elements 46 are formed preferably to be wedge-shaped and taper towards the cutting gap 36 such that these have a small radius of curvature towards the cutting gap. These belt guiding elements 46 likewise served to deflect the supporting element 35 which is formed, in particular, as an endless belt.

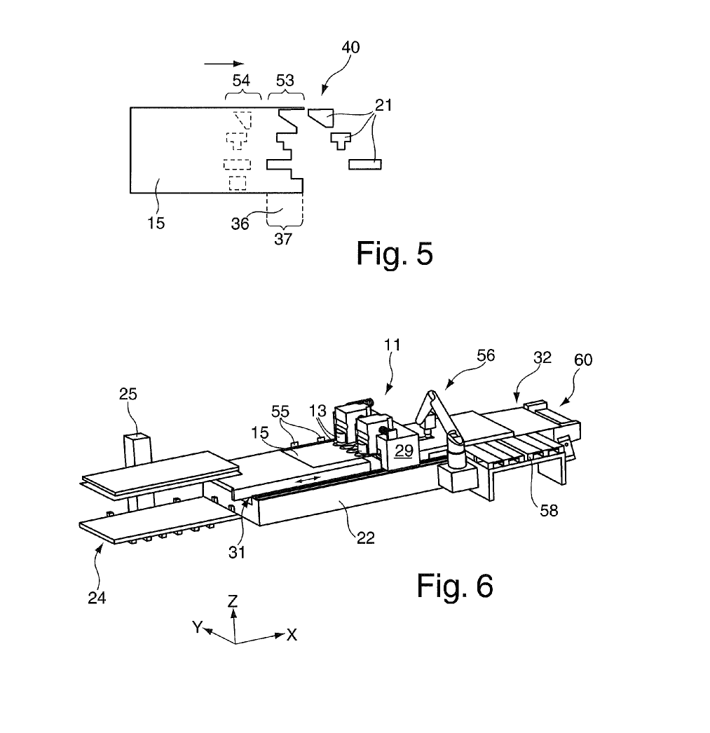

In FIG. 5, a schematic view from above onto a plate-shaped material 15 is depicted which is already processed on its front-side peripheral region 40 in a first strip-shaped section 53, and in which a second strip-shaped section 54 is pending for subsequent processing. The workpieces to be cut from the second strip-shaped section 54 are depicted, for example, by a dashed line.

In the case of the method illustrated in FIG. 5, the individual workpieces 21 are separated and are transported away from the remaining plate-shaped material 15, separated from one another, via the second work table 32 into an unloading zone 26, and are removed from the plate-shaped material 15. The contours remaining on the plate-shaped material 15 still lie, for example, over the cutting gap 36, which is depicted by a dashed line.

This method to produce workpieces is described more precisely below in FIGS. 7a to 7f by means of individual process steps. This method can be carried out on one machine tool 11 according to FIGS. 1 and 2, in which the unloading device 27 is formed, for example, as a storage container or batch container, which receives the individual workpieces 21.

Alternatively, the machine tool 11 can be formed according to FIG. 6. Substantially the structure of this machine tool 11 corresponds to the embodiment according to FIGS. 1 and 2. Additionally, a pallet 58 is provided at the end of or adjacent the supporting table 32, on which the separated workpieces 21 are removed from the supporting table 32 by an additional handling device 56, in particular using a single or multi axis robot, and are deposited on the pallet 58. Due to the removal of the workpieces 21 little by little from the processing region 30, a reliable removal of all workpieces 21 can occur. Larger workpieces 21, which cannot be gripped by the handling device 56, are deposited on a deposit table 60 via a supporting table 32. This deposit table 60 can comprise a scissor lift table such that the individual workpieces can be stacked on this one after the other with a low level of noise.

In FIGS. 7a to 7f, the individual process steps to produce a workpiece 21 according to a first embodiment of the method are described, in which both the waste parts 65 and the parts of the skeleton 61 are transferred downwards through the cutting gap 36 and only the workpiece(s) 21, as is depicted in FIG. 5, are transported away via the second work table 32.

FIG. 7a shows the positioning of the unprocessed plate-shaped material 15 in a starting position towards the cutting gap 36, as was described in FIG. 3, wherein the parallel dashed lines depict the cutting gap width 37. After the plate-shaped material 15 has been positioned in this starting position, a first contour 57 is introduced by a separating cut according to FIG. 7b, wherein during the introduction of the contour 57, the cutting gap 36 is moved accordingly underneath the processing head 13 by movement of the supporting tables 31, 32. Subsequently, for example according to FIG. 7c, further separating cuts 52 are introduced, due to which the skeleton 61 is separated. According to FIG. 7d, the gap 36 is enlarged to the depicted gap width 37 subsequently to this, such that the skeleton 61 can be transferred downward. Subsequently, the gap width 37 narrows again according to FIG. 7e, and, for example, separating cuts for the waste part 65 are introduced into the workpiece 21 to be produced. Subsequently, the waste part 65 is likewise transferred downward through the cutting gap 36, with a corresponding gap width set and the gap positioned underneath the waste part 65. In a processing step following this according to FIG. 7f, the cutting gap 36 is made smaller and the workpiece 21 is substantially transferred over the width of the cutting gap in the X direction and a last separating cut 68 is carried out such that the workpiece 21 can be transported via the second supporting table 32. In this work step according to FIG. 7f, it is provided that the cutting gap width 37 is reduced and/or the gap 36 is positioned such that the recess 67 formed by the cut-out of the waste part 65 is supported such that catching on the cutting gap 36 is prevented. During the introduction of the last separating cut 68, the supporting element 35 of the second supporting table 32 is already powered in the X direction in order to retract the workpiece 21 from the processing region 30 of the processing head 13. The supporting element 35 therefore carries out a movement relative to the plate-shaped material 15.

An alternative embodiment of the method described above can consist in that instead of the process step according to FIG. 7d, in which the part or parts of the skeleton 61 are transferred downward, these are transported away after being separated via the second supporting table 32, the supporting element 35 of which is likewise powered directly after the separation of the skeleton 61. For example, an additional handling device can be provided which removes the skeleton parts or transfers the skeleton parts into a batch container at the end of the supporting table 32, and the workpieces 21 are removed via the handling device 56 on the supporting table 32.

Furthermore, alternatively to the handling device 56, universal surface grippers can be used, as long as only workpieces 21 are transported away on the supporting table 32. Due to the transfer of the workpieces 21 one after the other via the second supporting table 32, it is furthermore advantageous that both the handling device 56 and a universal gripper do not have to work in the same parts cycle of the workpiece processing.

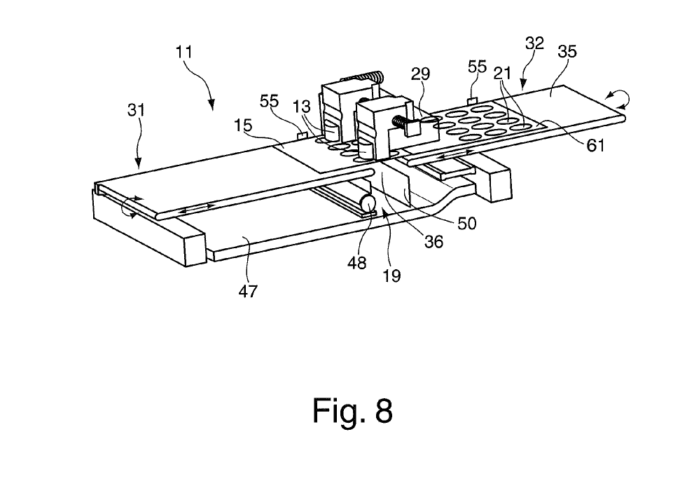

A further alternative embodiment of the method to produce workpieces 21 from a plate-shaped material is shown in FIGS. 8 and 9, in which the workpieces 21 remain in the resulting skeleton 61 after being cut free from the plate-shaped material 15, and are transported together out of the processing region 30. Only the waste parts 65 are transferred downwards through the cutting gap 36. The workpieces 21 remaining in the skeleton 61 can be completely cut free or can remained connected to the skeleton 61 by a micro joint 66.

In FIG. 8, the machine tool of FIGS. 1 and 2 is depicted performing an alternative method described below, in which a part of the plate-shaped material 15 is already processed and is depicted on the second supporting table 32, with the workpieces 21 remaining in the skeleton 61.

In FIGS. 9a to 9c, the individual process steps of the alternative method are described in more detail. The plate-shaped material 15 to be processed is again, as is depicted in FIG. 3, transferred into a starting position. Subsequently, waste parts 65 are cut into the front-side peripheral region 40 to produce inner contours in a workpiece 21. Preferably, a strip-shaped processing of the plate-shaped material is performed, in that first the strip-shaped section 53 is processed. During this processing, the cutting gap is moved underneath the contour 57 and set to such a width that a waste part 65, for example, can be completely cut without changing the gap width 37. Alternatively it can also be provided, in particular in the case of larger waste parts, that the cutting gap is carried corresponding to the separating cut to produce the contour, such that individual surfaces of the waste part are again supported on the first or second supporting table 31,32. Subsequently, as shown in in FIG. 9b, the waste part 65 is transferred downward via the cutting gap 36. For this purpose the gap width can be set in order to transfer the waste part 65 or the waste parts 65 downward through the gap. Subsequently, the gap width is again adapted and reduced for the subsequent work process. According to FIG. 9c, a contour of the workpiece 21 is cut, with the exception of the last separating cut 68. Subsequently, the plate-shaped material 15 is conveyed in the X direction (or the gap 36 is moved in the opposing direction), such that the gap lies exclusively underneath the contour for the last separating cut 68. Preferably the workpieces 21 are nested in such a way that a common last separating cut for several workpiece parts 21 is enabled during a setting and positioning of the gap 36.

According to a first variant of this alternative embodiment of the method, it is then provided that the last separating cut 68 is carried out. As the workpieces 21 are already substantially supported on the second supporting table 32, a tipping and catching is avoided. Additionally, these are no longer transferred back over the cutting gap 36. The separating cuts can be made tightly such that a tipping and catching-free removal of the workpieces from the skeleton 61 is possible. Subsequently, the adjacent strip-shaped section 54 is processed analogously to the process steps described above according to FIGS. 9a, 9b, and 9c, as is depicted in FIG. 9d.

After the entire plate-shaped material 15 has been processed, the skeleton 61 resulting from this and the workpieces 21 remaining therein are conveyed out of the processing region 30 via the supporting table 32. The workpieces 21 can then be removed via a universal gripper or via a handling device 56. Alternatively, a further sorting device can also be provided in order to separate the workpieces 21 from the skeleton 61, which are deposited in an unloading device 27. Likewise, a mutual depositing of the skeleton 61 and the remaining workpieces 21 in a stack can occur.

A further variant of the alternative embodiment described above provides that the process steps of FIGS. 9a to 9c are carried out but with a variation in the last separating cut 68, leaving at least one micro joint 66 between the workpiece 21 and the skeleton 61. The provision of micro joints 66 is particularly useful if the workpieces fall below a critical size, in order to prevent them from tipping into the cutting gap ahead of time. The micro joints 66 are separated after the last work step to produce the workpieces 21, as soon as it is ensured that moving over the cutting gap 36 is no longer necessary for the processing of the strip-shaped section 53. Thus, in a last cutting processing, the micro joints 66 are separated with the plate-shaped material 15 positioned according to FIG. 9c, after the workpiece 21 substantially lies on the second supporting table 32 and no longer has to be transferred over the cutting gap. In the case of the processing by setting micro joints 66, alternatively all workpieces 21 of the plate-shaped material 15 can be processed so far by separating cuts, such that the connection of the workpieces to the skeleton 61 is formed exclusively by the micro joints 66. Subsequently, the cutting gap 36 is moved by movement of the supporting tables 31, 32 under the skeleton 61, while the micro joints 66 in a given strip-shaped section 53 are separated by the processing head 13. Directly after the separating cut(s) (52) of the micro joints 66 in a strip-shaped section, the workpieces 21 of this section 53 are transported away with the help of the second supporting table 32, without it having to be moved once more over the cutting gap 36.

1-11. (canceled)

12. A method of producing and separating workpieces from plate-shaped material, the method comprising:
supporting plate-shaped material on a workpiece support comprising first and second supporting surfaces defining therebetween a cutting gap positioned under the processing region of a processing head of a machine tool, at least one of the two supporting surfaces being movable to change a width of the gap, the second supporting surface disposed downstream of the cutting gap with respect to a material transfer direction;
introducing separating cuts into the plate-shaped material to form features of at least one workpiece while leaving each workpiece connected to surrounding plate-shaped material at one or more connection points;
removing non-workpiece portions of the plate-shaped material through the cutting gap; and then
cutting through the connection points to free each workpiece from the surrounding plate-shaped material while the workpiece is supported by the second supporting surface so as to be subsequently moved away from the processing region by the second supporting surface without again crossing the cutting gap.

13. The method of claim 12, wherein
the plate-shaped material is supported on the first supporting table before beginning a first of the separating cuts and is positioned with a front-side peripheral region facing the cutting gap; and
the separating cuts are introduced into the front-side peripheral region of the plate-shaped material to form features of at least one workpiece in the front-side peripheral region;
the method further comprising, after cutting through the connection points, transporting the freed workpiece away from the processing region by the second supporting surface.

14. The method of claim 13, further comprising transferring the removed non-workpiece portions of the plate-shaped material from the cutting gap to an unloading zone away from the freed workpiece.

15. The method of claim 13, wherein the workpieces are nested within strip-shaped sections of the plate-shaped material aligned parallel to the cutting gap, and wherein the plate-shaped material is processed to be strip-shaped.

16. The method of claim 15, wherein the nesting of the workpieces is such that the connection points connecting multiple workpieces to the surrounding plate-shaped material are aligned within the width of the cutting gap.

17. The method of claim 13, wherein the freed workpiece is transported away from the processing region by motion of the second supporting surface while a remaining portion of the plate-shaped material remains stationary in the processing region.

18. The method of claim 12, wherein introducing the separating cuts separates waste parts bordering workpiece edges, the method further comprising:
removing the separated waste parts through the cutting gap;
narrowing the cutting gap to a gap width smaller than a dimension of the workpiece in the feed direction;
at least partially cutting an outer contour of the workpiece, the workpieces remaining within a resulting skeleton of the plate-shaped material; and then
removing the workpiece from the processing region together with the skeleton.

19. The method of claim 18, wherein outer contours of workpieces below a predetermined size are cut in such a way that a micro joint remains between each workpiece and the resulting skeleton.

20. The method of claim 19, wherein the micro joints between the workpieces and the skeleton are cut in such a way that the micro joints are disposed at an upstream side of each respective workpiece in the feed direction.

21. The method of claim 19, comprising, following introduction of all separation cuts to be introduced into the plate-shaped material, separating the workpieces from the skeleton by severing each micro joint while a substantial part of the respective workpiece attached by the micro joint being severed is disposed downstream of the cutting gap with respect to the feed direction.

22. The method of claim 19, wherein the predetermined workpiece size is less than 100 mm.

23. The method of claim 12, wherein the plate-shaped material is held in a fixed manner in the processing region by a clamping device during introduction of the separating cuts.

24. The method of claim 12, wherein the non-workpiece portions of the plate-shaped material removed through the cutting gap comprise portions of a skeleton of the plate-shaped material surrounding multiple workpieces.
